(19) United States
(12) Patent Application Publication
(10) Pub. No.: US 2021/0027550 A1
(43) Pub. Date: Jan. 28, 2021

(54) VEHICLE MAINTENANCE MINDER COUNTER SETTING

(71) Applicant: Honda Motor Co., Ltd., Tokyo (JP)

(72) Inventors: Jianhua ZHEN, Marysville, OH (US); David J. WISHIN, Marysville, OH (US); Takumi MAKABE, Dublin, OH (US)

(21) Appl. No.: 16/519,255

(22) Filed: Jul. 23, 2019

(51) Int. Cl. G07C 5/00; G07C 5/02; G07C 5/08; F02D 41/14

(52) U.S. Cl. CPC G07C 5/006; G07C 5/02; F02D 2041/228; F02D 41/1497; G07C 5/0808

(57) ABSTRACT

A method, system, and apparatus for updating a maintenance minder for a motor vehicle is disclosed. The motor vehicle includes an engine and an electronic ignition system. The maintenance minder counter is in electronic communication with the ECU, and a meter identifies to a user when the vehicle has reached a predetermined number of hours of operation of the engine. The ON/OFF status of an ignition switch that is part of the electronic ignition system is detected, the engine rotations per minute (RPM) are measured with a sensor, and the ON/OFF status and engine RPM are reported to the ECU. The maintenance minder counter is activated if the ON/OFF status is ON and the engine RPM exceeds a predetermined threshold.

### TECHNICAL FIELD

The embodiments herein relate to a method, system, and apparatus for calculating time for a maintenance appointment for a motor vehicle. More specifically, the embodiments provide a method and system for detecting a triggering event that results in the counting of elapsed time.

### BACKGROUND

Existing methods and systems for the upkeep and maintenance of vehicles are limited in their ability to inform users about recommended vehicle service. Examples of existing service or maintenance information systems include warning lights that are activated upon the detection of certain conditions, such as low oil levels, etc. One way to identify when service is required is to calculate an elapsed time of operation since the last service appointment. However, there exists a need to properly define when and how to calculate or meter elapsed time that ensures the user is instructed to obtain service when it is actually necessary. In particular, the electrical system of a vehicle may be operational when the engine is not running or in a severely idled state such that oil is not being used or consumed by the engine. Any elapsed time of operation should be limited to when the engine of the vehicle is using or consuming oil.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a method for updating a maintenance minder for a motor vehicle, the motor vehicle including an engine and an electronic ignition system, based upon a maintenance minder counter in electronic communication with the electronic ignition system reaching a predetermined number of hours of operation of the engine, includes the steps of detecting an ON/OFF status of an ignition switch that is part of the electronic ignition system, measuring engine rotations per minute (RPM) with a sensor, providing the ON/OFF status and engine RPM to the maintenance minder counter, and activating the maintenance minder counter if the ON/OFF status is ON and the engine RPM exceeds a predetermined threshold.

According to another aspect, a maintenance minder system for a motor vehicle, the motor vehicle including an engine and an electronic ignition system, includes an electronic control unit (ECU) for controlling the engine and in electronic communication with the electronic ignition system, the ECU having a processor and a maintenance minder counter, and a sensor for measuring engine rotations per minute (RPM) in electronic communication with the ECU. The ECU receives an ON/OFF status from the electronic ignition system and engine RPM from the sensor, the ECU communicates the ON/OFF status and the engine RPM to the processor module, and the processor module activates the maintenance minder counter if the ON/OFF status is ON and the engine RPM exceeds a predetermined threshold.

According to yet another aspect, an electronic ignition system includes a three-position ignition switch having an OFF position, an ON position, the ON position enabling power to be supplied to the motor vehicle from a source of electrical energy, and a start position, the engine of the motor vehicle being started when in the start position, the electronic ignition system returning to the ON position after the three-position ignition switch is disengaged, an electronic control unit (ECU) for controlling the engine, the ECU having a processor module and a maintenance minder counter, and a sensor for measuring engine rotations per minute (RPM) in electronic communication with the ECU. The ECU receives an ON/OFF status from the three-position ignition switch and engine RPM from the sensor, the ECU communicates the ON/OFF status and the engine RPM to the processor module, and the processor module activates the maintenance minder counter if the ON/OFF status is ON and the engine RPM exceeds a predetermined threshold.

### BRIEF DESCRIPTION OF THE DRAWINGS

FIG. 1 is a schematic view of a maintenance minder system for use with a motor vehicle.

FIG. 2 is a schematic view of an ignition switch for use with the maintenance minder system of FIG. 1.

FIG. 3 is a flowchart of a method of operating the maintenance minder system of FIG. 1.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

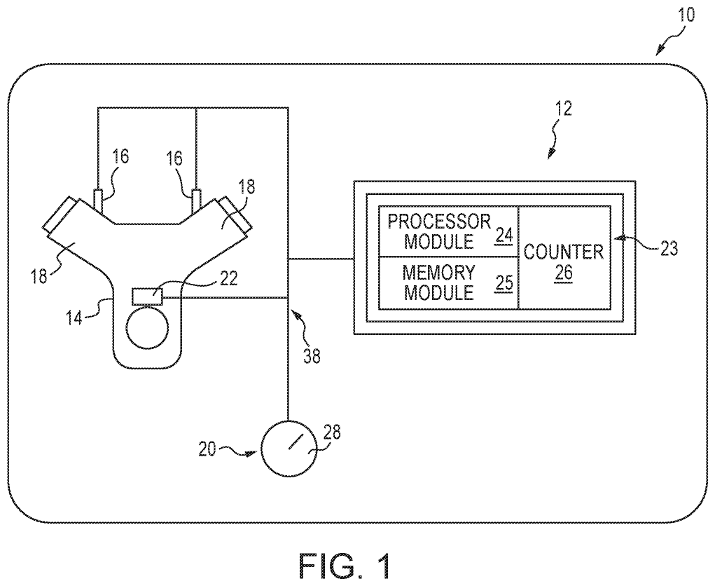

FIG. 1 illustrates a schematic representation of a maintenance minder system 12 of a motor vehicle 10. The motor vehicle 10 is powered by a conventional internal combustion engine 14 having a spark plug 16 disposed in a cylinder 18 for driving the engine 14. The motor vehicle 10 further includes an electronic ignition system 20 for starting the engine 14. The maintenance minder system 12 includes a sensor 22 for detecting a specific characteristic of the engine 14 to be monitored, and an electronic control unit (ECU) 23 that includes a processor module 24 operatively coupled to the electronic ignition system 20 and the sensor 22 and a memory module 25 operatively coupled to the processor module 24. One of the functions included within the processor module 24 is that of a maintenance minder counter 26, which counts the specific characteristic of the engine 14 detected by the sensor 22.

The maintenance minder counter 26, which is in electronic communication with the electronic ignition system 20, for example, may signal to the user of the motor vehicle 10 when the counts of the specific characteristic of the engine 14 have been achieved or recorded indicating that service is now required. Service may include, but is not limited to, an oil change in the engine 14, a coolant change, the change of other fluids related to the engine 14, the rotation of tires, and other routine and periodic services required that are known to those skilled in the art.

One method for the maintenance minder system 12 to determine that servicing of the motor vehicle 10 is required is to determine that the engine 14 has been in operation for a predetermined number of hours. One embodiment for determining the number of hours of operation of the engine is to first detect an ON/OFF status of an ignition switch 28 that is part of the electronic ignition system 20 that is in operative communication with the processor module 24 and the maintenance minder counter 26. When the ignition switch 28 is judged ON, the maintenance minder counter 26 begins collecting measurements of rotations per minute (RPM) of the engine 14 with the sensor 22. The sensor 22 may be a dedicated RPM sensor solely connected to and for use by the processor module 24 and the maintenance minder counter 26, or the sensor 22 may be a tachometer associated with general operation of the motor vehicle 10.

Once the ON/OFF status of the ignition switch 28 is judged ON and RPM of the engine 14 is communicated to the maintenance minder counter 26, the maintenance minder counter 26 may be activated if the RPM of the engine 14 exceeds a predetermined threshold RPMₘᵢₙ. For this embodiment, the predetermined threshold RPMₘᵢₙ may be set between 250-750 Hz, and most probably such that RPMₘᵢₙ=500 Hz.

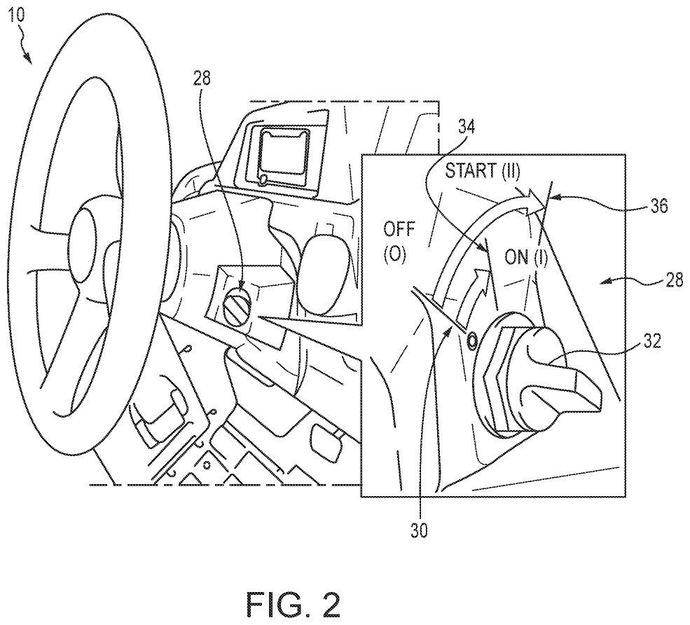

The ignition switch 28 may be a three-position, key-operated switch used to start and stop the engine 14 located in cabin of the motor vehicle 10 as illustrated schematically in FIG. 2. When the ignition switch 28 is in an OFF (O) position 30, as shown in FIG. 2, the engine 14 and all electrical circuits are off. The key 32 can be inserted and removed only when it is in the OFF (O) position 30. When the ignition switch 28 is in the ON (I) position 34, the electrical circuits are on. The accessory power socket (not shown) may also be used while the key is moved to the ON (I) position. When the ignition switch 28 is in an START (II) position 36, the engine 14 is started. Once the engine 14 is started, the key 32 will automatically return to the ON (I) position 34 when the operator of the motor vehicle 10 releases the key 32. The ON/OFF status of the ignition switch 28 is not solely used to activate the maintenance minder counter 26 because ignition switch 28 may be in an ON (I) position 34 to enable access to the electrical system of the motor vehicle 10, but if key has not been turned to the START (II) position 36, the engine 14 will not be running.

In this scenario, running the maintenance minder counter 26 could suggest service is required earlier than necessary, and further more often than necessary. By employing the embodiments discussed herein, more accurate maintenance minder information may be provided to the operator of the motor vehicle 10.

Returning to operation of the maintenance minder system 12, the processor module 24 may check and/or receive ignition status from the ignition switch 28 and RPM of the engine 14 from the sensor 22 at specified time intervals, which in the present embodiment is approximately every 10 milliseconds, over the Controller Area Network (CAN bus) 38 of the motor vehicle 10. Alternatively, the data may be transmitted between the sensor 22 and the processor module 24 through serial or direct connection.

At such time as the processor module 24 and the maintenance minder counter 26 detect that either the ON/OFF status of the ignition switch is OFF, or the RPM of the engine 14 drops below the predetermined threshold RPMₘᵢₙ, the maintenance minder counter 26 stops counting the elapsed time t of operation of the motor vehicle 10. The elapsed time t may be stored in the memory module 25. The elapsed time t may be recovered from the memory module 25 and the calculation resumed when the ON/OFF status of the ignition switch is ON and the RPM of the engine 14 exceeds the predetermined threshold RPMₘᵢₙ.

Additionally, at such time as the elapsed time t equals or exceeds a specified time tₘ, the operator of the motor vehicle 10 may be alerted that service for the motor vehicle 10 is required in a method known to those skilled in the art.

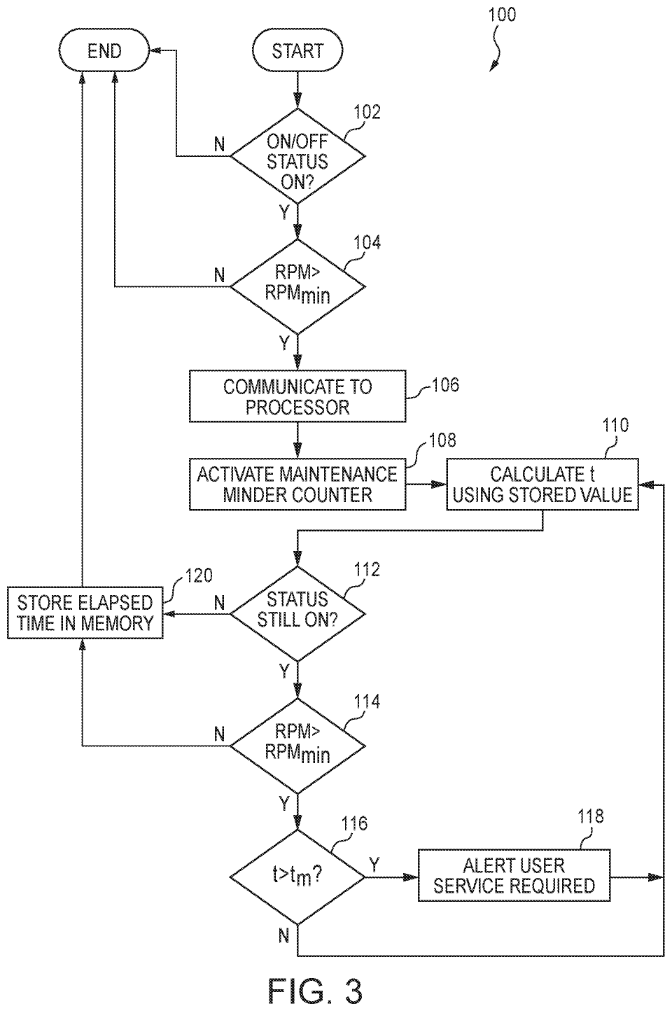

FIG. 3 is a flowchart that shows the operation of the maintenance minder system 12 as described in the embodiments herein. A method 100 of updating a maintenance minder counter 26 for a motor vehicle 10 includes the first step 102 of detecting the ON/OFF status of an ignition switch 28 that is part of the electronic ignition system 20. If the ignition switch is judged ON, the method proceeds to the step 104 of measuring RPM of the engine 14 with the sensor 22. The ON status and detected RPM of the engine 14 are electronically communicated over the CAN bus 38 to the processor module 24 of the ECU 23 in step 106. Alternatively, the data may be transmitted to the processor module 24 through serial or direct connection.

In step 108, the processor module 24 activates the maintenance minder counter 26 to continue counting elapsed time t, adding to the previously calculated elapsed time t stored in the memory module 24, if the ON/OFF status is ON and the engine 14 RPM exceeds a predetermined threshold RPMₘᵢₙ as illustrated in step 110. As previously mentioned, RPMₘᵢₙ may be set between 250-750 Hz, and in the embodiment illustrated is set around 500 Hz. If the RPM is less than RPMₘᵢₙ, the method 100 ends. In steps 112 and 114, after the maintenance minder counter 26 begins to calculate elapsed time t, the maintenance minder system 12 continues to check the ON/OFF status of the ignition switch (in step 112) and the RPM status of the engine 14 (in step 114) in a loop every 10 milliseconds.

In step 116, the new elapsed time t is compared to a stored value tₘ. Once elapsed time t is judged to exceed stored value tₘ, the user of the motor vehicle 10 is alerted service is required in step 118. In the event the ON/OFF status of the ignition is moved to OFF in step 112 or RPM is measured below RPMₘᵢₙ in step 114, the maintenance minder counter 26 stops calculating elapsed time t and stores the updated value of the elapsed time t in the memory module 24 in step 120. After the method 100 ends, the method 100 may begin again if the ON/OFF status changes again in step 102.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A method of updating a maintenance minder for a motor vehicle, the motor vehicle including an engine and an electronic ignition system, based upon a maintenance minder counter in electronic communication with the electronic ignition system reaching a predetermined number of hours of operation of the engine, comprising the steps of:
detecting an ON/OFF status of an ignition switch that is part of the electronic ignition system;
measuring engine rotations per minute (RPM) with a sensor;
providing the ON/OFF status and engine RPM to the maintenance minder counter; and
activating the maintenance minder counter if the ON/OFF status is ON and the engine RPM exceeds a predetermined threshold.

2. The method of claim 1 further comprising the step of:
detecting the ON/OFF status of the ignition switch;
measuring the engine RPM; and
deactivating the maintenance minder counter if the ON/OFF status of the ignition switch is OFF or the engine RPM is below the predetermined threshold.

3. The method of claim 2 wherein the predetermined threshold is between 250 and 750 RPM.

4. The method of claim 3 wherein the predetermined threshold is 500 RPM.

5. The method of claim 1 wherein the sensor is a tachometer.

6. A maintenance minder system for a motor vehicle, the motor vehicle including an engine and an electronic ignition system, comprising:
an electronic control unit (ECU) for controlling the engine in electronic communication with the electronic ignition system, the ECU including a processor module and a maintenance minder counter;
a sensor for measuring engine rotations per minute (RPM) in electronic communication with the ECU;
wherein the ECU receives an ON/OFF status from the electronic ignition system and engine RPM from the sensor;
wherein the ECU communicates the ON/OFF status and the engine RPM to processor module; and
wherein the processor module activates the maintenance minder counter if the ON/OFF status is ON and the engine RPM exceeds a predetermined threshold.

7. The system of claim 6 wherein the processor module deactivates the maintenance minder counter if the ON/OFF status of the ignition switch is OFF.

8. They system of claim 7 wherein the processor module deactivates the maintenance minder counter if the engine RPM is below the predetermined threshold.

9. The system of claim 8 wherein the predetermined threshold is between 250 and 750 RPM.

10. The system of claim 9 wherein the predetermined threshold is 500 RPM.

11. The system of claim 10 wherein the ECU and the maintenance minder meter are connected by a CAN bus.

12. The system of claim 11 wherein the ECU communicates the ON/OFF status of the electronic ignition system and the engine RPM to the processor module repeatedly at specified interval of time.

13. The system of claim 12 wherein the specified interval of time is 10 milliseconds.

14. The system of claim 13 wherein the ECU provides indicia to an operator when the maintenance minder counter reaches a predetermined level.

15. The system of claim 6 wherein the electronic ignition system comprises:
a three-position ignition switch, comprising:
an OFF position;
an ON position, the ON position enabling power to be supplied to the motor vehicle from a source of electrical energy; and
a start position, the engine of the motor vehicle being started when in the start position, the electronic ignition system returning to the ON position after the three-position ignition switch is disengaged.

16. An electronic ignition system, comprising:
a three-position ignition switch, comprising:
an OFF position;
an ON position, the ON position enabling power to be supplied to the motor vehicle from a source of electrical energy; and
a start position, the engine of the motor vehicle being started when in the start position, the electronic ignition system returning to the ON position after the three-position ignition switch is disengaged
an electronic control unit (ECU) for controlling the engine having a processor module and a maintenance minder counter;
a sensor for measuring engine rotations per minute (RPM) in electronic communication with the ECU;
wherein the ECU receives an ON/OFF status from the three-position ignition switch and engine RPM from the sensor;
wherein the ECU communicates the ON/OFF status and the engine RPM to the processor module; and
wherein the processor module activates the maintenance minder counter if the ON/OFF status is ON and the engine RPM exceeds a predetermined threshold.

17. The electronic ignition system of claim 16 wherein the processor module deactivates the maintenance minder counter if the ON/OFF status of the ignition switch is OFF.

18. They electronic ignition system of claim 17 wherein the processor module deactivates the maintenance minder counter if the engine RPM is below the predetermined threshold.

19. The electronic ignition system of claim 18 wherein the predetermined threshold is between 250 and 750 RPM.

20. The electronic ignition system of claim 19 wherein the predetermined threshold is 500 RPM.
